(19) United States
(12) Patent Application Publication
(10) Pub. No.: US 2026/0339857 A1
(43) Pub. Date: Oct. 29, 2026

(54) LIMIT ON A SYNCHRONIZATION RATE FOR MOVEMENT OF DATA

(71) Applicant: Hewlett Packard Enterprise Development LP, Spring, TX (US)

(72) Inventors: Omer Uretzky, Ramat Hasharon (IL); Gil Barash, Tel-Aviv (IL)

(21) Appl. No.: 19/188,848

(22) Filed: Apr. 24, 2025

(51) Int. Cl. G06F 13/20

(52) U.S. Cl. CPC G06F 13/20; G06F 2213/40

(57) ABSTRACT

Provided herein are techniques for providing synchronization data and write IOs associated with a protected volume from a protected site to a vault site. Specifically, corresponding mini journals of the protected site and vault site are used to replicate the synchronization data and write IOs between periodic intervals when data communications are disabled between the protected site and vault site. A limit on the rate of movement of synchronization data from a protected volume to the mini journal may be imposed, resulting in reduced movement of synchronization data from the protected volume to the mini journal during the periodic intervals.

### BACKGROUND

Data protection in a computer system may involve keeping multiple copies of the data to be protected in or across multiple different devices such that, in the case of the failure of one or more of the devices, the data may be retrieved from one or more of the other (non-failing) devices. Such examples may avoid data loss due to device failure.

### DRAWINGS

Aspects and advantages of the present disclosure will become better understood when the following detailed description is read with reference to the accompanying drawings, wherein:

FIG. 1 is a schematic diagram, illustrating a system that implements continuous data protection (CDP) via protected volume synchronization limited by an adaptive synchronization rate limit, in accordance with examples of the present disclosure;

FIG. 2 is a flowchart, illustrating a process for implementing CDP including protected volume synchronization limited by an adaptive synchronization rate limit, in accordance with examples of the present disclosure;

FIG. 3 is a flowchart, illustrating a synchronization process limited by an adaptive synchronization rate, in accordance with examples of the present disclosure;

FIG. 4 is a flowchart, illustrating a process for determining an adaptive synchronization rate limit, in accordance with examples of the present disclosure;

FIG. 5 is a flowchart, illustrating a process for generating a recovery volume from synchronization data and write IOs provided to the vault site, in accordance with examples of the present disclosure; and

FIG. 6 is a schematic diagram, illustrating an example of CDP that provides protected volume synchronization limited by an adaptive synchronization rate limit, in accordance with examples of the present disclosure.

### DETAILED DESCRIPTION

Continuous data protection (CDP) is a data backup process that replicates each write input/output (IO) made to a protected volume to a backup volume. For example, when data is written to the protected volume, a copy of the write IO may be replicated to a journal that aggregates and stores the write IOs. The stored write IOs may be used to maintain a backup of the data (herein referred to as “backup data”) of the protected volume in a backup volume. In some cases, checkpoints may be associated with the replicated write IOs at periodic checkpoint intervals (e.g., every 5 seconds), enabling recovery of the protected volume at selected checkpoints. As such, a recovery volume may be created using (in part) the write IOs up to, but not beyond, a selected checkpoint in the journal.

For increased protection, the backup data may be transferred from a hardware environment hosting the protected volume (herein referred to as a “protected site”) to one or more vault volumes of a vault storage device of a secure hardware environment (herein referred to as a “vault site”). In the event of a data-loss event (e.g., through cyber-attack, hardware fault, etc.), the backup data stored in the vault volumes of the vault site may be used in data recovery of the lost data.

The vault site may be an enhanced security environment, protected from intrusion via techniques such as “air gapping.” As used herein, air gapping refers to an isolation technique where network communication to the vault site (including between the protection storage device and the vault site) is disabled during periodic intervals of predefined length, but enabled between the periodic intervals. Enabling network communication between the periodic intervals (e.g., such as every 4 hours for a 2-hour duration) allows particular types of data (e.g., replicated backup data) to be copied into the vault site between the periodic intervals. The network communication may be disabled by disabling all communication connections to the vault storage device or the vault site. In this manner, the vault storage device and/or vault site may receive the backup data between the periodic intervals (when the communication to the vault storage device is enabled) while reducing access vulnerabilities (e.g., by limiting data communication to the vault storage device during the periodic intervals).

Examples described herein relate to providing resource-efficient and reliable continuous data protection (CDP) using corresponding mini journals at the protected site and the vault site. The mini journals may be used to transfer batches of backup data from the protected site to the vault site. During the periodic intervals, accumulated copies of the write IOs to the protected volume may be stored in the mini journal at the protected site (which may be referred to herein as the “protected mini journal”). Between the periodic intervals, the accumulated copies of the write IOs stored in the protected mini journal may be transferred to the mini journal at the vault site (which may be referred to herein as the “vault mini journal”), enabling the vault site to maintain the backup data.

To provide continuous data protection of the protected volume, at least one vault volume may be kept synchronized to the protected volume. A replication process may copy, to the protected mini journal, write IOs targeting the protected volume as they are written to the protected volume as well as corresponding checkpoints (e.g., interval timestamps). The protected mini journal may aggregate and store the data written to the protected volume during each periodic interval. At the end of the periodic interval, the network communication to the vault storage device is restored (e.g., by enabling network communication connections to the vault site), enabling the data aggregated in the protected mini journal to be replicated to the vault site through the restored network communication channel(s). In some examples, the write IOs aggregated in the protected mini journal may be replicated to a vault mini journal at the vault site, and the write IOs replicated to the vault mini journal may be applied to the vault volume. In such examples, the state of the data in the vault volume during a current periodic interval may lag behind the state of the data in the protected volume by up to two consecutive periodic intervals worth of write IOs to the protected volume. Specifically, the vault volume may lag the protected volume by the write IOs targeting the protected volume in the current periodic interval (represented by data present in the protected mini journal) and the write IOs targeting the protected volume the prior periodic interval (represented by data present in the vault mini journal). In such examples, the vault volume may be considered to be in synchronization (i.e., “in sync”) with the protected volume, as it lags the protected volume by no more than the data in-flight to the vault volume via the protected mini journal and the vault mini journal.

However, in some cases, the vault volume may be or become out of synchronization (i.e., “out of sync”) with the protected volume by an amount greater than the data in-flight to the vault volume via the protected mini journal and the vault mini journal. For example, when continuous data protection is started for a volume (now the protected volume), the data initially present in that volume will not be in-flight in the mini journals. In such examples, the continuous data protection process would start with the protected volume and the vault volume out of sync based on the data initially present in the protected volume, and copying incoming write IOs to the protected volume, as described above, would not copy the initially present data to the vault volume. As such, a separate synchronization process may be used to copy the data initially present in the protected volume to the vault volume to bring the vault volume into sync with the protected volume. The data to be copied from the protected volume to the vault volume by the synchronization process may be referred to herein as “synchronization data”. The data initially present in the protected volume, as described above, is one example of such synchronization data.

Synchronization data may also accumulate during continuous data protection. For example, write IOs received during a given periodic interval may exceed the capacity of the protected mini journal, resulting in the protected mini journal becoming “overrun”. When the protected mini journal is overrun, some of the write IOs received in the given periodic interval are applied to the protected volume but are not copied to the protected mini journal during that periodic interval. In such examples, the data present in the protected volume as a result of the uncopied write IOs becomes synchronization data to be copied to the vault volume by a subsequent synchronization process.

Accordingly, to maintain synchronization of the vault volume(s) to the protected volume, a synchronization process may copy synchronization data from the protected volume to the protected mini journal for transfer to the vault site. When synchronization data has accumulated as a result of write IOs overrunning the protected mini journal during a given periodic interval, the synchronization process may copy synchronization data from the protected volume to the protected mini journal during one or more subsequent periodic intervals.

To transfer synchronization data from the protected volume to the vault volume, the synchronization process may retrieve the synchronization data from the protected volume and copy it to the protected mini journal while write IOs received during the periodic interval are also copied into the protected mini journal. However, if too much synchronization data is copied to the protected mini journal during a given periodic interval, the capacity of the protected mini journal may be depleted before the end of the periodic interval, which may result in write IOs overrunning the protected mini journal, thereby creating more synchronization data and extending the amount of time that the vault volume is out of sync with the protected volume.

This increase in synchronization data may result in numerous issues, such as prolonging the synchronization process, which may result in increased usage of processing resources for the synchronization process, and an increased amount of time when the vault volume is out of sync, which may limit the checkpoints available for data recovery (e.g., later checkpoints may not be available until after a synchronization process).

To address these issues, examples described herein may control the rate at which a synchronization process may copy synchronization data into the protected mini journal during a periodic interval while write IOs received during that periodic interval are also copied into the protected mini journal. In this manner, examples described herein may mitigate overrunning the protected mini journal when copying write IOs and synchronization data to the protected mini journal during a given periodic interval, such that write IOs received during the given periodic interval may be reliably copied to the protected mini journal for transfer to the vault site at the end of the periodic interval. In this manner, the reliability of data recovery may be improved.

In some examples, to retain enough capacity in the protected mini journal to store all write IOs received in a current periodic interval, a synchronization rate limit (e.g., a read rate limit from the protected volume and/or a write rate limit to the mini journal from the protected volume) may be iteratively determined and applied for limiting the rate of movement of the synchronization data from the protected volume to the mini journal. For example, the synchronization rate limit may be based on: a rate of write IOs in at least one of: a current periodic interval or one or more prior periodic intervals; an amount of available capacity remaining in the mini journal; and a time left before an end of the current periodic interval. In some cases, the synchronization rate may be determined in accordance with the expression:

$$\frac{C - W * T}{T} ,$$

where C is the capacity of the mini journal, W is the maximal rate of the write IOs in the current and the previous periodic intervals, and T is the time left in the current periodic interval. This expression may be used to estimate how much room is left in the mini journal for protected volume data and may cap a rate of movement of synchronization data from the protected volume to the mini journal based upon that estimate. As the current periodic interval passes and synchronization data and/or write IOs are copied into the mini journal, the remaining capacity of the mini journal changes, and the time left in the current periodic interval changes. Thus, the synchronization rate over the periodic interval may dynamically adjust as these changes occur.

Synchronization data may be written from the protected volume to the protected mini journal at a rate no greater than the determined synchronization rate limit. In this manner, a portion of the synchronization data from the protected volume may be written to the mini journal in conjunction with received write IOs, while ensuring that there is enough capacity to store an estimated number of received write IOs.

By limiting the amount of synchronization data copied to the protected mini journal during a given periodic interval, capacity of the protected mini journal is reserved for write IOs received during the given periodic interval, helping to reserve enough capacity in the protected mini journal to hold the write IOs received by the protected volume during the given periodic interval. In this manner, examples described herein may reduce protected mini journal overruns, and the synchronization data that may result from overruns. Such examples may decrease the amount of time when the vault volume(s) are out of sync with the protected volume, thereby likely increasing the reliability of the data protection.

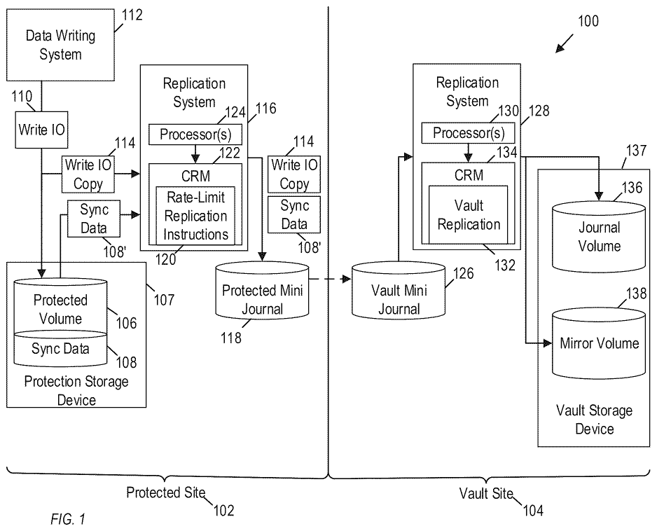

FIG. 1 is a schematic diagram, illustrating an example system 100 that implements continuous data protection (CDP) via protected volume synchronization performed at an adaptive synchronization rate, in accordance with aspects of the present disclosure. As illustrated, the system 100 includes a protected site 102 and a vault site 104. The protected site 102 includes a protection storage device 107 comprising a protected volume 106, a replication system 116, and a protected mini journal 118. The vault site 104 includes a replication system 128, a vault mini journal 126, and a vault storage device 137 comprising vault volumes, including a journal volume 136 and a mirror volume 138. Protected mini journal 118 may be implemented in storage of any suitable computing device(s) of protected site 102 (e.g., protection storage device 107, replication system 116, another storage device of protected site 102, etc.). Vault mini journal 126 may be implemented in storage of any suitable computing device(s) of vault site 104 (e.g., vault storage device 137, replication system 128, another storage device of vault site 104, etc.).

Functionalities described herein in relation to replication system 116 may be implemented by execution, by one or more processors 124, of computer-readable instructions (referred to herein as “rate-limit replication instructions” 120) stored on one or more non-transitory machine-readable storage medium (CRM) 122. Functionalities described herein in relation to replication system 128 may be implemented by execution, by one or more processors 130, of computer-readable instructions (referred to herein as “vault replication instructions” 132) stored on one or more non-transitory machine-readable storage medium (CRM) 134. Functionalities described herein in relation to protected site 102 may be performed by replication system 116 (e.g., implemented by processor(s) executing instructions 120), and functionalities described herein in relation to vault site 104 may be performed by replication system 128 (e.g., implemented by processor(s) executing instructions 134). In examples described herein a data writing system 112 may issue write IOs 110 to the protection storage device 107 targeting the protected volume 106, and replication system 116 may replicate copies of write IOs 110 (write IO copies 114) and synchronization data 108 to the protected mini journal 118 for subsequent transmission to the vault site 104. Copies 114 of write IOs 110 may be referred to herein as “write IO copies” 114. The replication system 116 may replicate the protected mini journal 118 of protected site 102 to the vault mini journal 126 of the vault site 104 between periodic intervals. Protected mini journal 118 may be sized to hold at least a cumulative number and/or size of write IO copies 114 expected to be received by the protection storage device 107 and targeting the protected volume 106 in a periodic interval. The protected mini journal 118 is smaller in capacity than the protected volume 106. Vault mini journal 126 may receive the data held in the protected mini journal 118, and may be sized similarly to the protected mini journal 118.

Replication system 116 replicates write IOs 110 of the protected volume 106 (via copies 114) along with associated checkpoints (e.g., timestamps), to enable restoration of data of the protected volume 106 at a particular checkpoint. Checkpoints may be associated with the write IOs 110 at particular times (e.g., every 5 seconds) to indicate times associated with the write IOs and, thus, enabling data restoration to be performed with respect to one of these checkpoints (e.g., by selectively restoring a portion of the write IOs 110 of the protected volume 106 up to the specified checkpoint). The replicated data (which may be referred to herein as “backup data”) may be stored at the vault site 104, which may provide additional data integrity features to protect the backup data. For example, the vault site 104 may store the backup data in an immutable state, where the backup data may not be altered, deleted, or modified once stored. Further, the vault site 104 may be periodically air-gapped, meaning that the vault site 104 (or components thereof, such as replication system 128 and vault storage device 137) may be isolated from network communications during periodic intervals of time (e.g., by disabling one or more network communication channels to the vault site 104 or components thereof). The network communications may be enabled during a communication window between the periodic intervals of time (e.g., from the end of one periodic interval to the start of another periodic interval), enabling data replication from the protected site 102 to the vault site 104 between the end of one periodic interval and the start of another periodic interval. As may be appreciated, the immutable storage and/or air-gapping implemented at the vault site 104 may provide additional protection of the replicated data from cyber threats, unauthorized access, and/or other nefarious activities.

To provide CDP on the protected volume 106, replication system 116 may identify synchronization data 108 to synchronize from the protected volume 106 to vault volume(s) of the vault site 104 and/or write IOs 110 written to the protected volume 106 during the current periodic interval to be provided as backup data to the vault site 104. Write IOs 110 may occur when a data writing system 112 (e.g., a server, virtual machine, and/or other computing device or processing system) writes data to the protected volume 106 (e.g., via write IOs 110).

Because network communications to the vault site 104 may be disabled during periodic intervals of time and communication to the vault site 104 may be limited to the communication windows between the periodic intervals of time, the protected mini journal 118 may act as a buffer, storing data to be transmitted to the vault site 104 until a communication window occurs and the data can be transferred to the vault site 104.

For example, in response to a write IO 110 generated by the data writing system 112, a write IO copy 114 of the write IO 110 may be generated. The rate-limit replication instructions 120, when executed by the processor(s) 124, may cause the processor(s) 124 to provide the write IO copy 114 to the protected mini journal 118 for subsequent provision to a corresponding vault mini journal 126 of the vault site 104 during a communication window.

As mentioned above, portions of synchronization data 108 may also be replicated to the protected mini journal 118 from the protected volume 106. Synchronization data 108 of the protected volume 106 may be replicated to bring the vault volumes (e.g., journal volume 136 and/or mirror volume 138) into synchronization with the protected volume 106, as described above. For example, in one case, synchronization data 108 may include initial data, such as base replica data, stored in the protected volume 106 prior to initializing copying of write IO copy 114 into the protected mini journal 118. In another case, synchronization data 108 may include data in the protected volume 106 corresponding to write IOs 110 (e.g., written in a previous periodic interval) where a write IO copy 114 of one or more of the write IOs 110 has not been copied to the protected mini journal 118 (e.g., because the protected mini journal 118 capacity was depleted when the write IO 110 was written to the protected volume such that there was an overrun).

The rate-limit replication instructions 120, when executed by the processor(s) 124, may identify that synchronization data 108 exists in the protected volume 106 and cause a portion 108′ of the synchronization data 108 to be transferred into the protected mini journal 118. To preserve capacity in the protected mini journal 118 for storage of all of the write IO copies 114 corresponding to write IOs 110 written in a current period interval, a synchronization rate limit may be imposed via the rate-limit replication instructions 120. The synchronization rate limit provides a limit on the size of the portion 108′ of the synchronization data 108 that may be copied to and stored in the protected mini journal 118 during a current periodic interval, thus avoiding depletion of capacity of the protected mini journal 118 by storage of the portion 108′ of the synchronization data 108 prior to storage of all write IO copies 114 for the current periodic interval being written to the protected mini journal 118. This may help to ensure there is capacity within the protected mini journal 118 to store an amount of write IO copies 114 expected during the current periodic interval.

The rate-limit replication instructions 120, when implemented by the processor(s) 124 may cause the replication system 116 to calculate the synchronization rate limit for movement of synchronization data 108 from the protected volume 106 to the protected mini journal 118 during a current periodic interval. The synchronization rate limit may indicate a rate limit on reading synchronization data 108 from the protected volume 106 and/or a rate limit on writing the synchronization data 108 to the protected mini journal 118. In either case, the synchronization rate limit may limit an amount of the synchronization data 108 transferred to the protected mini journal 118 in a current periodic interval, to maintain capacity within the protected mini journal 118 for the estimated amount of incoming write IO copies 114 for the current periodic interval.

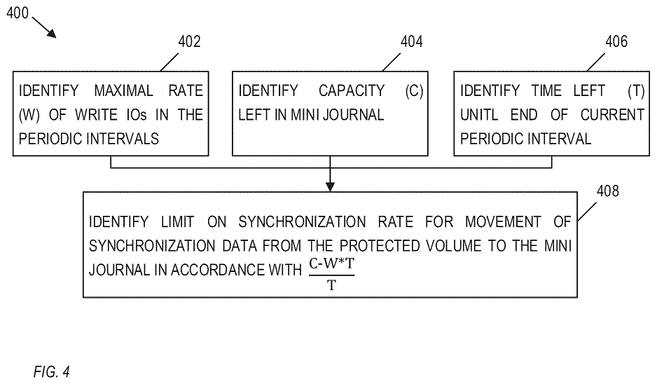

The synchronization rate limit may be based upon a predicted amount of the capacity of the protected mini journal 118 expected to remain after preserving a portion of the capacity of the protected mini journal 118 for storage of the estimated amount of write IO copies 114 still expected to be stored in the protected mini journal 118 during the current periodic interval. A detailed description of one process for calculating the synchronization rate limit is described in more detail below with regard to FIG. 4.

As time passes in a current periodic interval, write IO copies 114 and portions 108′ of the synchronization data 108 may be transferred into the protected mini journal 118, so the available capacity of the protected mini journal 118 and/or expected amount of incoming write IOs 110 for the current periodic interval may change. Accordingly, the synchronization rate limit may dynamically change as these changes occur. Thus, at the beginning of a periodic interval, the synchronization rate limit may be higher than at the end of the current periodic interval, when less capacity exists in the protected mini journal 118. In other examples, the synchronization rate limit may be higher toward the end of the current periodic interval if fewer write IOs 110 than expected were received in the current periodic interval.

Between pairs of consecutive periodic intervals (e.g., at the end of a periodic interval and before a subsequent periodic interval) a communication window occurs, where network communications to the vault site 104 may be enabled (e.g., by enabling one or more network communication channels to vault site 104 or component(s) thereof) such that data may be communicated between the protected mini journal 118 and the vault mini journal 126. In such examples, between pairs of consecutive periodic intervals, replication system 116 may transfer the data in protected mini journal 118 to the corresponding vault mini journal 126 of the vault site 104. As (and/or after) the data is replicated from the protected mini journal 118 of the protected site 102 to the vault mini journal 126 of the vault site 104, the replicated data of the protected mini journal 118 may be over-written, enabling the protected mini journal 118 to hold new data received from the replication system 116 during a subsequent periodic interval. In some cases, the protected mini journal 118 and corresponding vault mini journal 126 may each be implemented as respective circular buffers, enabling over-writing of data in the protected mini journal 118 as it is replicated from the protected mini journal 118 to the vault mini journal 126. In each periodic interval, data may be written to a designated start (e.g., block offset 0 and/or some other starting block offset) of the protected mini journal 118, effectively resulting in overwriting the protected mini journal 118 in each periodic interval. At the end of the periodic interval, a designated ending point (e.g., ending block offset) of the protected mini journal 118 where data was written is identified, indicating an end of data to be transferred from the protected mini journal 118 to the corresponding vault mini journal 126.

The replication system 128 may store data from the vault mini journal 126 (which may be referred to herein as “replication data”) in one or more vault volumes (e.g., journal volume 136 and/or mirror volume 138) of one or more vault storage device(s) 137. For example, during the communication window, the replication data is provided from the protected mini journal 118 to the vault mini journal 126 and the replication system 128 may retrieve the replication data from the vault mini journal 126 and cause the replication data to be stored in the journal volume 136 and/or the mirror volume 138. For example, in some cases, the mirror volume 138 may be maintained as a replica of the protected volume 106 up to a given point in time, and journal volume 136 may store write IO copies 114 and associated checkpoints (e.g., timestamps inserted at 5 second intervals) for write IOs 110 issued after the given point in time. In some examples, mirror volume 138 may serve as a replica for protected volume 106 after being initialized (e.g., by applying to mirror volume 138 synchronization data 108 representing the initial data that was stored in protected volume 106 before beginning CDP for protected volume 106). In such examples, write IO copies 114 stored in journal volume 136 may be incrementally applied to the mirror volume 138. Progressively applying the write IO copies 114 in journal volume 136 to mirror volume 138 updates mirror volume 138 to represent the state of protected volume 106 at progressively later points in time. In such examples, the earliest point in time that may be restored at a given time is the point in time represented by the present state of mirror volume 138. To recover to a subsequent checkpoint (i.e., to a later point in time that what is represented by mirror volume 138) the write IO copies 114 in journal volume 136 up to the subsequent checkpoint may be applied to a restored version of mirror volume 138.

In some examples, there may be more synchronization data 108 in the protected volume 106 than may be transferred to the protected mini journal 118 during a given periodic interval, due to the synchronization rate limit and/or the capacity of the protected mini journal 118. Accordingly, in some cases, not all synchronization data 108 may be stored in the protected mini journal 118 in a single periodic interval for communication to the vault mini journal 126 in a subsequent communication window. In such cases, different portions 108′ of synchronization data 108 may be stored in the protected mini journal 118 during a plurality of periodic intervals and these portions 108′ of the synchronization data 108 may be provided from the protected mini journal 118 to the vault mini journal 126 across a plurality of communication windows. Thus, the synchronization data 108 may be incrementally provided across a plurality of communication windows, by incrementally providing respective portions 108′ of the synchronization data 108 in each of the communication windows. As portions 108′ of the synchronization data 108 are provided to the vault site 104 (e.g., by replicating the portion 108′ of the synchronization data 108 to the protected mini journal 118), remaining portions of the synchronization data 108 to be transferred to the vault site 104 may be tracked, for example by maintaining a record of the portions 108′ of synchronization data 108 transferred to the protected mini journal 118 and/or vault site 104 and subtracting the portions 108′ of the synchronization data 108 transferred from the entirety of the synchronization data 108.

When no more synchronization data 108 exists in the protected volume 106, the replication system 116 may replicate write IO copies 114 to the protected mini journal 118 independent of (e.g., without being interleaved with) synchronization data 108 from protected volume 106. In such examples, the vault mini journal 126 may receive write IO copies 114 from protected mini journal 118 in a communication window independent of synchronization data 108 from the protected volume 106. These write IO copies 114 may be stored in the journal volume 136, enabling creation of new recovery volumes using these write IO copies 114.

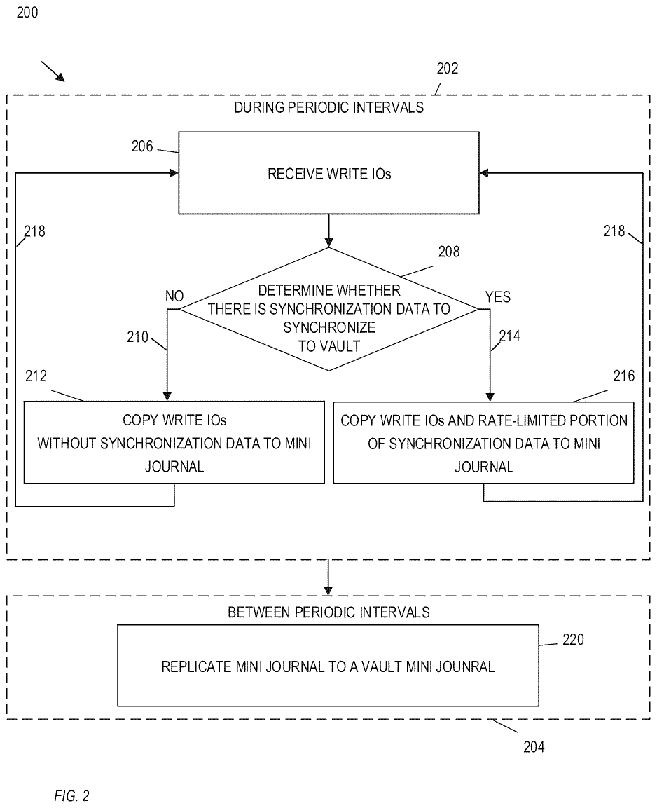

FIG. 2 is a flowchart, illustrating a process 200 for implementing CDP via protected volume synchronization using an adaptive synchronization rate, in accordance with aspects of the present disclosure. CDP may include replicating backup data (e.g., synchronization data and write IOs written during a periodic interval) with corresponding checkpoints to a vault site, such that recovery volumes of the protected volume may be generated at a particular checkpoint. Thus, in the event of a data loss event with respect to the protected volume, the lost data, as it existed at a specified one of the checkpoints, may be restored. The process 200 may be implemented at a protected site, such as protected site 102 of FIG. 1, by one or more computers, such as the replication system 116 of FIG. 1 (e.g., as rate-limit replication instructions 120 executed by the processor(s) 124).

As mentioned above, a vault site (e.g., vault site 104 of FIG. 1) may be protected from unauthorized data access, by disabling data communications (e.g., by disabling communication connections to the vault site) during periodic intervals of time. Data communications may be enabled (e.g., by enabling communication connections to the vault site) between these periodic intervals. Accordingly, the process 200 includes a first subset of processes 202 that occur during the periodic intervals and a second subset of processes 204 that occur between the periodic intervals (e.g., between an end of a periodic interval and the start of a next periodic interval).

During the periodic intervals, the first subset of processes 202 of the process 200 includes receiving write IOs (e.g., write IOs 110 of FIG. 1) (block 206). The write IOs may be received by identifying and copying write IOs targeting a protected volume (e.g., a volume being protected via CDP, such as protected volume 106 of FIG. 1). The write IOs may include any data write operation targeting the protected volume, such as addition of a block of data, deletion of a block of data, and/or overwrite of a block of data.

A determination is made as to whether there is any synchronization data to synchronize to the vault site (decision block 208). As mentioned above, the synchronization data is data of the protected volume that is out of sync at the vault volume and is not in-flight to the vault volume via the protected mini journal or the vault mini journal. For example, synchronization data to transfer to the vault site may be identified by identifying blocks of data stored in the protected volume prior to receiving the write IOs in block 206. In another case, synchronization data to transfer to the vault site may be identified when a write IO was received in a previous periodic interval, but was not written to the protected mini journal due to lack of capacity in the protected mini journal.

When there is no synchronization data to synchronize to the vault site (illustrated by arrow 210), the write IOs are copied (e.g., write IO copies 114) to a mini journal (e.g., protected mini journal 118 of the protected site 102 of FIG. 1) without synchronization data (block 212). In this manner, the write IOs written to the protected volume may be stored in the mini journal for transfer to the vault site during the next enabled data communication window (e.g., at the end of the current periodic interval).

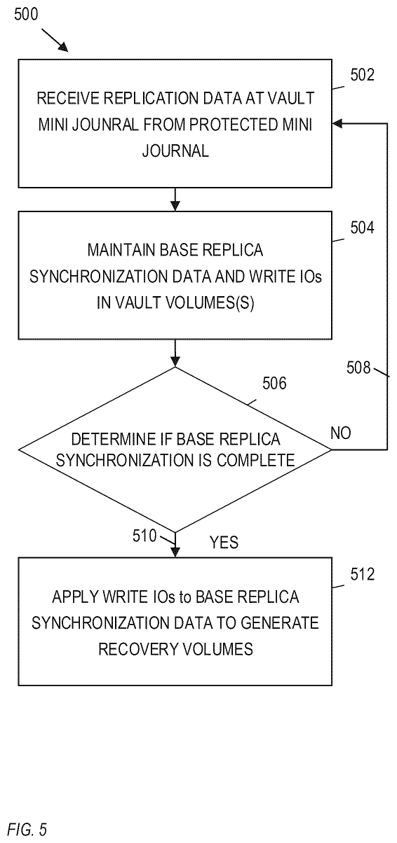

When there is synchronization data to synchronize to the vault site (illustrated by arrow 214), the write IOs are copied to the mini journal with a rate-limited portion of the synchronization data (block 216). In other words, the capacity of the mini journal may be used to store both the write IOs and a portion of the synchronization data. To avoid running out of capacity in the protected mini journal, a limit on data provided for storage in the mini journal may be imposed. The number and/or rate of write IOs may be dependent on the data writing system providing the write IOs. Accordingly, reducing the number and/or rate of write IOs may reduce a performance of the data writing system. Thus, a synchronization rate (e.g., a rate of movement of synchronization data from the protected volume to the mini journal) may be limited, thereby reducing an amount of synchronization data provided to the mini journal and thereby preserving capacity of the mini journal for received write IOs (e.g., of block 206). Because the data copied to the protected mini journal may include interleaved write IOs and synchronization data, metadata may be associated with the data copied to the mini journal, indicating a type of the data (e.g., write IO or synchronization data). This metadata may be used in storage of the backup data and/or reconstruction of the recovery volumes from the data, as will be described in more detail below with respect to the process of FIG. 5. Further, the data copied to the protected mini journal may include an indication of an associated offset of the protected volume enabling ordering of the data for data recovery and cyclic redundancy check (CRC) data for data verification.

As illustrated by arrows 218, blocks 206-216 may iteratively repeat during each of the periodic intervals, resulting in iterative copying of write IOs and/or synchronization data to the mini journal. As new write IOs and synchronization data is copied to the mini journal, factors impacting the synchronization rate limit (e.g., the capacity of the mini journal, a rate of write IOs, and/or a time until the end of the current periodic interval) may change. Accordingly, the synchronization rate limit may adjust (e.g., at each iteration and/or at a periodic interval) such that a dynamically optimized rate of synchronization data may be applied while copying synchronization data to the mini journal. In this manner, the amount of synchronization data stored in the mini journal may be granularly controlled, resulting in efficient capacity utilization of the mini journal, even when the rate of incoming write IOs varies over the periodic interval.

Between pairs of consecutive periodic intervals, the second subset of processes 204 of the process 200 includes replicating the mini journal (e.g., copying the write IOs and/or synchronization data of blocks 212 and/216 stored in the mini journal) to a corresponding vault mini journal of the vault site (e.g., vault mini journal 126 of FIG. 1) (block 220). In this manner, the write IOs and/or synchronization data stored in the mini journal during the most-recent periodic interval are copied to a corresponding vault mini journal on the vault site between the periodic intervals, while data communications to the vault site are enabled.

Process 200 may iteratively repeat, capturing new write IOs and/or synchronization data for transfer to the vault site across a number of different periodic intervals and transferring these write IOs and/or synchronization between corresponding periodic intervals. The vault site may enable generation of recovery volumes once all remaining synchronization data to be provided to the vault site is copied to the mini journal during a most-recent periodic interval. This vault site process is discussed in more detail with respect to FIG. 5, below.

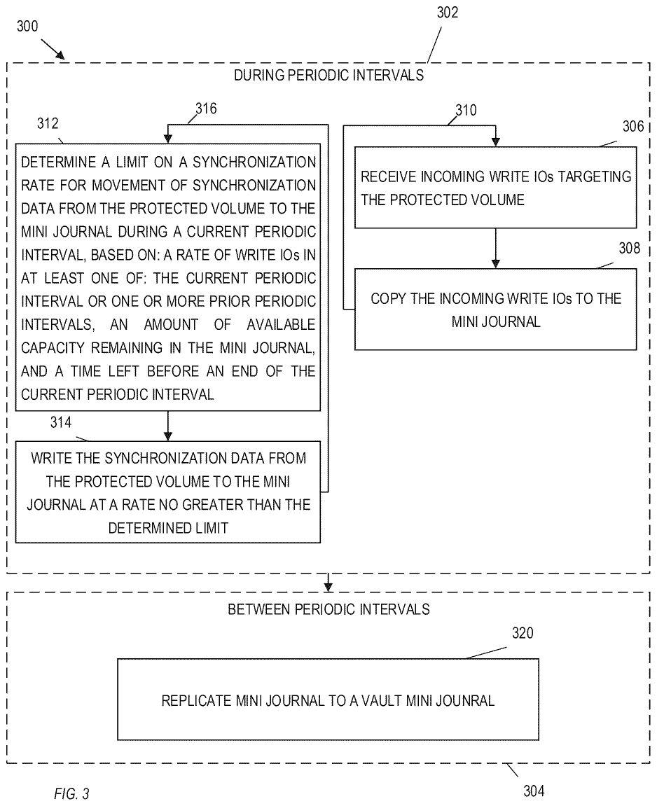

Having discussed the process 200 for implementing CDP via protected volume synchronization using an adaptive synchronization rate, FIG. 3 is a flowchart, illustrating details of a synchronization process 300 that uses an adaptive synchronization rate to provide both synchronization data (e.g., synchronization data 108) and write IO copies (e.g., write IO copies 114 of FIG. 1) via mini journals (e.g., from a protected site mini journal to a vault mini journal), in accordance with aspects of the present disclosure. The synchronization process 300 illustrates certain characteristics that may dictate a limit on synchronization rate to help ensure there is enough capacity in the protected mini journal to store all write IOs generated during periodic interval.

As mentioned above, the vault site may be protected from unauthorized data access, by disabling data communications during periodic intervals of time. Data communications may be enabled between these periodic intervals. Accordingly, the synchronization process 300 includes a first subset of processes 302 that occur during the periodic intervals and a second subset of processes 304 that occur between the periodic intervals.

As illustrated, during the periodic intervals, the first subset of processes 302 of the synchronization process 300 includes receiving the incoming write IOs (e.g., write IOs 110 of FIG. 1) targeting the protected volume (block 306). For example, a data writing system 112 may be monitored for generation of write IOs targeting a protected volume (e.g., protected volume 106 of FIG. 1). These write IOs may include any modification targeting a data block of the protected volume.

In response to receiving the incoming write IOs, a copy of each of the incoming write IOs is written to a mini journal on the protected site (e.g., protected mini journal 118 of FIG. 1) (block 308). Checkpoints may also be written to the mini journal at certain time intervals (e.g., every 5 seconds). The checkpoints provide timestamp intervals enabling selection of a subset of the write IOs associated with a particular time for data recovery.

As illustrated by arrow 310, blocks 306 and 308 may iteratively repeat during each of the periodic intervals. Thus, as new write IOs are applied to the protected volume, these write IOs may be received and copied to the mini journal for subsequent provision to a corresponding vault site mini journal after the current periodic interval.

Additionally, during the periodic intervals, a limit on a synchronization rate for movement of synchronization data from the protected volume to the mini journal during a current periodic interval is determined (block 312). The limit on the synchronization rate may help ensure that there is enough capacity in the mini journal to store all of the copied write IOs of block 308, by limiting an amount of the synchronization data that is written to the mini journal during a given periodic interval. The limit on the synchronization rate may be determined based upon an estimated size of write IOs that will be received in the remaining amount of time of the periodic interval and how much of the remaining capacity of the mini journal will be used by the estimated size of write IOs. Specifically, the limit on the synchronization rate may be determined based upon: 1) a rate of write IOs in at least one of: the current periodic interval or one or more prior periodic intervals, 2) an amount of available capacity remaining in the mini journal, and 3) a time left before an end of the current periodic interval.

The synchronization data is written from the protected volume to the mini journal at a rate no greater than the determined limit (block 314). The limit on the synchronization rate may help ensure that there is enough capacity in the mini journal to store all of the copied write IOs of block 308, by limiting an amount of the synchronization data that is written to the mini journal during a given periodic interval.

As illustrated by arrow 316, blocks 312 and 314 may iteratively repeat (e.g., at an iterative time interval, such as every second, minute, etc.) during each of the periodic intervals. Further, as may be appreciated, when no further synchronization data remains to be synchronized to the vault site, blocks 312 and/or 314 may cease (e.g., until additional synchronization data to be synchronized to the vault site is identified). The limit on the synchronization rate may dynamically update (e.g., at each iteration of blocks 312-314) based upon changes in one or more of the variables that the synchronization rate limit is based on. For example, if there are more expected write IOs (e.g., due to an increased rate of write IOs) and/or a decrease in capacity of the mini journal, the limit on the synchronization rate may decrease, reducing the rate of synchronization data that is copied to the mini journal and, thus, preserving more capacity for write IOs.

Between the periodic intervals, the second subset of processes 304 of the synchronization process 300 includes replicating the mini journal to a corresponding vault mini journal of the vault site (e.g., vault mini journal 126 of FIG. 1) (block 320). Thus, the synchronization data written to the mini journal during the current periodic interval and the write IOs copied to the mini journal may be provided to the vault site, where this data may be protected and/or reconstructed into recovery volumes.

FIG. 4 is a flowchart, illustrating a process 400 for determining a limit on the synchronization rate (e.g., the limit on the synchronization rate used in block 312 of FIG. 3), in accordance with aspects of the present disclosure. The limit on the synchronization rate may act to preserve capacity of the mini journal (e.g., protected mini journal 118 of FIG. 1) that is estimated to be needed for storage of copies of write IOs (e.g., write IOs 110 targeting the protected volume 106 and/or an estimated size of write IO copies 114 in FIG. 1) written to the protected volume in the current periodic interval. This may help ensure that an amount of the mini journal capacity used to store the synchronization data does not exceed an amount that would hinder write IOs for a given periodic interval from being stored in the mini journal. In other words, the amount of synchronization data provided to the mini journal during a given periodic interval is limited to afford all write IOs of the given periodic interval to be copied to the mini journal.

To calculate the limit on the synchronization rate, the process 400 may include identifying a maximal rate of write IOs (“W”) in the periodic intervals (block 402). The rate of write IOs may include identifying a size (e.g., megabytes (Mb)) of write IOs generated from a data writing system (e.g., data writing system 112 of FIG. 1) targeting the protected volume (e.g. protected volume 106 of FIG. 1) over a unit of time (e.g., seconds(s)). As write IOs are generated and copied to the mini journal (e.g., in blocks 212 and 216 of FIG. 2) the total size of the accumulated write IOs per unit of time may be identified. In some cases, a maximal rate of these rates in the given periodic interval may indicate a maximal rate of write IOs for a given periodic interval, indicating the maximal rate of write IOs W. In some cases, the maximal rate of write IOs across all periodic intervals may be tracked and set as the maximal rate of write IOs W.

The process 400 may include identifying a capacity (“C”) left in the mini journal (block 404). C may be identified by tracking an amount of data (e.g., Mb) stored and/or provided for storage in the mini journal and subtracting this amount from a capacity of the mini journal.

The process 400 may include identifying a time left (“T”) until an end of the current periodic interval (block 406). T may be identified by tracking an amount of time in a current periodic interval and subtracting this amount of time from an overall amount of time of the periodic interval.

Using the identified variables (W, C, and T) of blocks 402-406, the limit on the synchronization rate on movement of synchronization data from the protected volume to the mini journal may be identified in accordance with the expression:

$$\frac{C - W * T}{T}$$

(block 408).

In this expression, multiplying W by T (W*T) may provide an estimate of remaining capacity of the mini journal that will be used by incoming write IOs in the current periodic interval (e.g., based upon a maximal rate of write IOs in the periodic intervals). Thus, subtracting this expected capacity from the capacity left in the mini journal (C−W*T) indicates a synchronization data capacity or remaining capacity of the mini journal left available for synchronization data after preserving capacity for incoming write IOs. To obtain the limit on the synchronization rate, this remaining capacity may be divided by the remaining time left in the periodic interval.

As may be appreciated, using the maximal rate of write IOs in the periodic intervals to identify the remaining capacity of the mini journal that will be used by the write IOs may provide a conservative estimate. Accordingly, in some cases, a less conservative approach may be implemented by, for example, using an average rate of write IOs across one or more of the periodic intervals. This may result in a faster provision of synchronization data to the vault site but may come with more of a risk that the mini journal capacity will be fully consumed before all copies of all write IOs of a periodic interval are copied to the mini journal, which may result in additional synchronization data.

Recovery volumes may be generated at the vault site from the replication data (e.g., the write IO data and/or synchronization data) that is provided to and stored at the vault site. FIG. 5 is a flowchart, illustrating a process 500 for generating recovery volumes from synchronization data and/or write IOs provided to the vault site (e.g., vault site 104 of FIG. 1), in accordance with aspects of the present disclosure. The process 500 may be implemented by a computing device, such as the replication system 128 of FIG. 1, via computer-readable instructions (e.g., vault replication instructions 132 of FIG. 1) stored on a non-transitory computer-readable medium (e.g., CRM 134 of FIG. 1) that are executed by one or more processors (e.g., processor(s) 130 of FIG. 1).

The process 500 includes receiving replication data (e.g., base replica synchronization data and/or write IOs (e.g., post-base replica modifications) at a mini journal (e.g., vault mini journal 126 of FIG. 1) of the vault site (“vault mini journal”) from a mini journal (e.g., protected mini journal 118 of FIG. 1) of a protected site (“protected mini journal”) (block 502). The replication data may be received between the periodic intervals, when data communications with the vault site are enabled. The replication data may include interleaved write IOs and synchronization data (e.g. as written to the mini journal in blocks 212 and/or 216 of FIG. 2) and replicated to the vault mini journal.

The base replica synchronization data and write IOs may be maintained in vault volumes (e.g., a journal volume, such as journal volume 136 and/or mirror volume 138 of FIG. 1) (block 504). This may entail storing the base replica synchronization data and write IOs in separate groups within one volume (e.g., in a journal of a vault volume) based upon the type indicated in the associated metadata (e.g., a write IO group for write IO copies and a synchronization data group for synchronization data) and/or storing the synchronization data and write IO copies in different volumes (e.g., storing the base replica synchronization data in a mirror volume and the write IO copies in a journal volume as illustrated in FIG. 1). These separate groups and/or volumes may be formed when storing the synchronization data and the write IOs in the protected mini journal, the vault mini journal, and/or the vault volumes. The ordering within each group and/or volume of replication data may be maintained in the vault journal across a plurality of communication windows. For example, ordering of the write IOs may be maintained in the write IO group for write IOs received in a plurality of communication windows and the ordering of the synchronization data may be maintained in the synchronization data group received in a plurality of communication windows.

At decision block 506, a determination is made as to whether base replica synchronization is complete. In other words, a determination is made as to whether all base replica synchronization data from the protected site has been received at the vault site to enable data recovery (e.g., via recovery volume generation). In some cases, this may be determined based upon a synchronization process status indication communicated from the protected site. In some cases, this may be determined when the replication data received at the vault site does not include any synchronization data.

Recovery volumes may be generated once all base replica synchronization data is received (e.g., the synchronization is complete). Accordingly, when synchronization is not complete (e.g., not all base replica synchronization data has been received, as illustrated by arrow 508), the process 500 may restart, continuing to receive new replication data until base replica synchronization is complete.

When base replica synchronization is complete (illustrated by arrow 510), the write IOs may be applied to the base replica synchronization data to generate recovery volumes (block 512). Specifically, the base replica synchronization data (e.g., existing before the write IO copies communicated to the vault mini journal 126) may be ordered before the write IOs and merged to form a recovery volume. A subset of the write IOs to apply may be selected based upon a desired recovery checkpoint. As mentioned previously, checkpoints are associated with the write IOs at time intervals (e.g., every 5 seconds) indicating when the when the write IOs occurred and enabling selection of write IOs associated with a particular checkpoint. For example, if a desired checkpoint was 10:00:05, all write IOs occurring after the base replica synchronization data up to 10:00:05 may be selected and applied to the base replica synchronization data to generate a recovery volume of protected volume as it existed at 10:00:05.

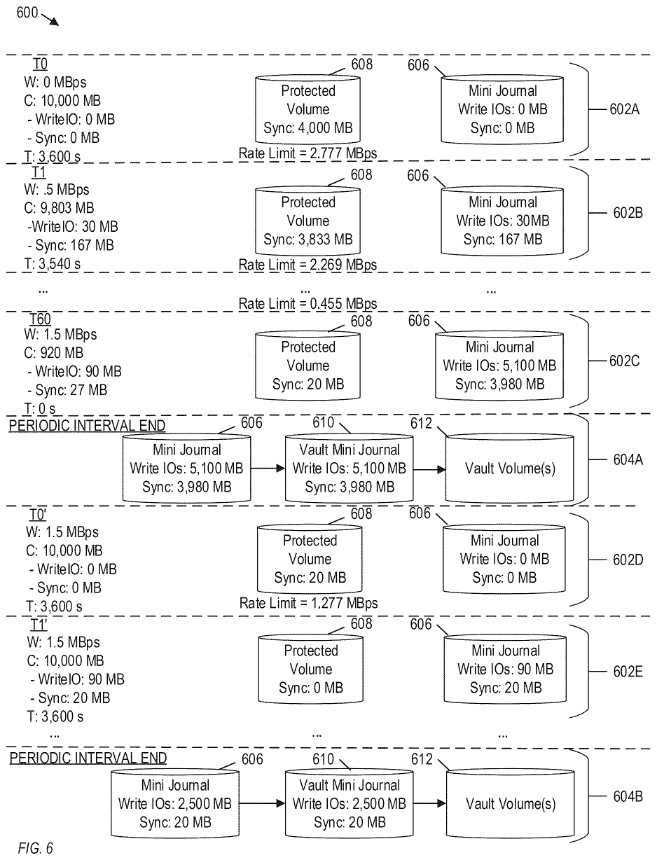

FIG. 6 is a schematic diagram, illustrating an example 600 of CDP that provides protected volume synchronization using an adaptive synchronization rate, in accordance with aspects of the present disclosure. FIG. 6 illustrates example time intervals 602A-E (collectively referred to as “time intervals 602”) (e.g., within a periodic time interval where data communications to a vault site are disabled) at which a limit on a synchronization rate is determined and applied, limiting an amount of synchronization data written from the protected volume to a mini journal. While FIG. 6 illustrates an example with 1 minute time intervals, other intervals, such as 0.1 second, 1 second, etc. time intervals may be used. FIG. 6 also illustrates times 604A-B between periodic intervals, where data is moved from the protected site to the vault site.

Starting first with time interval 602A labelled TO, this may be the first time interval within the periodic interval where no data has yet been stored in the mini journal 606 of a protected site (e.g., protected mini journal 118 of FIG. 1). As illustrated, the protected volume 608 includes 4,000 MB of synchronization data. Because no writes have yet been performed to the mini journal 606, the maximal write IO rate is set to 0 MBps. Further, the current example assumes the capacity (C) of the mini journal 606 is sized at 10,000 MB. Further, as illustrated 0 MB of write IOs and 0 MB of synchronization data has been written to the mini journal 606 at this point. Assuming a one-hour periodic interval, the time remaining at the start of the periodic interval is 3,600 seconds. With this initial information, the synchronization rate limit may be calculated in accordance with the expression:

$$\frac{C - W * T}{T}$$

as discussed above with respect to FIG. 4. Thus, the calculation for the synchronization rate limit may be:

$$\frac{10 , 000 MB - 0 MBps * 3600 s}{3600 s} = 2.7 \; 77 MBps .$$

As may be appreciated, this synchronization rate limit effectively assumes no write IOs will be copied to the mini journal 606 because the maximal rate of write IOs observed so far is 0 MBps. This estimate (and the corresponding synchronization rate limit) will change as write IOs are generated and written to the mini journal 606.

For example, at time interval 602B labelled T1 (e.g., one minute after TO), the write IOs have picked up, resulting in a rate of 0.5 MBps. Thus, assuming for simplicity that the rate is steady from T0 to T1, the size of the write IOs written to the mini journal 606 is 30 MB (0.5 MBps×60 s) and the time remaining in the periodic interval is reduced by 60 seconds to 3, 540 seconds. Additionally, checkpoints are written to the mini journal 606 at particular intervals (e.g., every 5 seconds) indicating, when the write IOs took place between time interval 602A T0 and time interval 602B T1).

The amount of synchronization data written from the protected volume 608 to the mini journal 606 is capped at the synchronization rate limit of 2.777 MBps, resulting in 167 MBps (2.777×60 s (rounded up) of synchronization data being copied from the protected volume 608 to the mini journal.

The capacity remaining in the mini journal is 9,803 MBs (10,000 MB-30 MB (taken up by write IOs)—167 MB (taken up by synchronization data). Further, the protected volume 608 has 3,833 MB of synchronization data left to be copied to the mini journal 600 for subsequent provision to the vault site (4,000 MB-167 MB (amount of synchronization data already copied to the mini journal 606). Using this data, a new rate limit is determined as 2.269 MBps from a calculation:

$$\frac{9 , 803 MB - \text{.5} MBps * 3 , 540 s}{3 , 540 s} = 2.2 \; 69 MBps .$$

The iterative dynamic calculation of the synchronization rate limit may continue for each of the time intervals 602 of the periodic interval(s). As illustrated by the time interval 602C labelled T60 (e.g., the last time interval of the periodic interval), the rate limit is set as 0.455 MBps from the previous time interval 602, resulting in 27 MB of synchronization data being copied to the mini journal 606, resulting in the synchronization data left in the protected volume 608 to be copied to the mini journal 606 at 20 MB. The capacity of the mini journal has reduced to 920 MB (10,000 MB-5,100 MB of write IOs and 3,980 MB of synchronization data). The maximal rate of write IOs for this periodic interval has increased to 1.5 MBps based upon this rate being observed in one of the time intervals 602.

The end of time interval 602C is the beginning of time 604A between periodic intervals. Between the periodic intervals, data communications between the mini journal and a corresponding mini journal on the vault site (“vault mini journal”) 610 may be enabled. Accordingly, during time 604A, the 5,100 MB of write IOs, the checkpoints, and 3,980 MB of synchronization data are copied to a corresponding mini journal on the vault site (e.g., at “vault mini journal” 610).

Once this data is received at the vault mini journal 610, the data may be retrieved at the vault site from the vault mini journal 610 (e.g., by the replication system 128 of FIG. 1) for storage in one or more vault volumes 612 (e.g., the mirror volume 138 and/or journal volume 136). As mentioned above, the base replica synchronization data may be separated from the post-base replica write IO modifications and corresponding checkpoints in the vault journal(s).

At the start of the next 1 hour (3,600 second) periodic interval (illustrated by time interval 602D labelled T0′, the protected volume 608 still has 20 MB of synchronization data to provide to the mini journal 606 for subsequent transfer to the vault site. Accordingly, a synchronization rate limit is calculated for movement of this synchronization data. As illustrated, the capacity is reset to 10,000 MB as the previously copied data in the mini journal 606 can be overwritten. The maximal rate of write IOs may be determined across the current periodic interval and the previous periodic intervals. Accordingly, because the previous periodic interval had a maximal rate of write IOs of 1.5 MBps and the current periodic intervals has not yet written any write IOs, the 1.5 MBps maximal rate of write IOs of the previous periodic interval is used for the synchronization rate limit calculation. Using this information, the synchronization rate limit is calculated as:

$$\frac{10 , 000 MB - 1.5 MBps * 3 , 600 s}{3 , 600 s} = 1.2 \; 77 MBps .$$

Accordingly, at time interval 602E labelled T1′, the amount of allowed synchronization data to be copied from the protected volume 608 to the mini journal 606 is 1.277 MBps×60 s=76.62 MB. Because the protected volume includes less than 76.62 MB of remaining synchronization data to be copied to the mini journal 606, the entirety of remaining synchronization data (e.g., 20 MB) is copied over to the mini journal 606.

At the end of the periodic interval the time 604B starts, where data communication between the mini journal 606 and the vault mini journal 610 is once again enabled. The write IOs (2,500 MB), corresponding checkpoints, and synchronization data (20 MB) of the previous periodic interval are copied to the vault mini journal 610.

Because all base replica synchronization data to be moved from the protected volume has been received at the vault site via the vault mini journal 610, recovery volumes may now be generated from the replication data stored in the vault volumes 612 (e.g., via the process 500 of FIG. 5). Further, because the write IO modifications are ordered in time and checkpoints have been inserted in the replication data, recovery volumes may be generated at any one of the checkpoints transferred in the replication data. This may be done by selectively applying write IO modifications up to the specified checkpoint to the base replica, resulting in generation of the checkpoint-specific recovery volume.

As may be appreciated, the current techniques provide improved data protection via dynamically adjusting an amount of synchronization data transmitted to a vault site between periodic intervals of disabled communication to the vault site. Specifically, by reducing a rate that synchronization data may be written to a mini journal tasked with aggregating write IOs written to a protected volume during a periodic interval, capacity of the mini journal may be preserved for any additional write IOs that will be written to the protected volume. This may reduce instances where the capacity of the mini journal is depleted prior to storage of all write IOs written during that periodic interval, resulting in fewer instances where one or more vault volumes of the vault site are out of synchronization with the protected volume and, thus, increasing reliability of the data protection.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A system, comprising:
a protected volume of a protection storage device;
a mini journal;
one or more processors; and
a non-transitory computer-readable medium comprising computer-readable instructions that are executable by the one or more processors to:
receive incoming write input/outputs (IOs) targeting the protected volume;
copy the incoming write IOs to the mini journal for replication to a vault volume of a vault storage device, wherein communication between the system and the vault storage device is disabled during periodic intervals of predefined length and enabled between the periodic intervals;
determine a limit on a synchronization rate for movement of synchronization data from the protected volume to the mini journal during a current periodic interval, based on:
a rate of write IOs in at least one of: the current periodic interval or one or more prior periodic intervals;
an amount of available capacity remaining in the mini journal; and
an amount of time left before an end of the current periodic interval;
writing at least some of the synchronization data from the protected volume to the mini journal at a rate no greater than the determined limit; and
at the end of the current periodic interval, replicate the mini journal to a vault mini journal of the vault storage device.

2. The system of claim 1, wherein the synchronization data comprises data written to the protected volume that is out of synchronization at the vault volume and is not in-flight to the vault volume via the mini journal or the vault mini journal.

3. The system of claim 1, wherein the mini journal has a capacity smaller than the protected volume and is sized to hold at least a cumulative number or size of incoming write IOs expected to be received by the protection storage device and targeting the protected volume in a periodic interval.

4. The system of claim 1, wherein the synchronization data comprises at least one of:
initial data stored in the protected volume prior to initializing copying of the incoming write IOs; or
write IOs not copied to the mini journal as a result of an overrun of the mini journal.

5. The system of claim 1, wherein the limit on the synchronization rate is calculated in accordance with:
$$\frac{C - W * T}{T} ,$$
where C is the amount of available capacity remaining in the mini journal, W is the rate of write IOs, and T is the time left before the end of the current periodic interval.

6. The system of claim 5, wherein the rate of write IOs comprises a maximal rate of: a maximal rate of write IOs in the current periodic interval and a maximal rate of write IOs in the one or more prior periodic intervals.

7. The system of claim 1, wherein the limit on the synchronization rate comprises at least one of: a rate limit on reading the synchronization data from the protected volume or a rate limit on writing the synchronization data to the mini journal.

8. A processor-implemented method, comprising:
receiving incoming write input/outputs (IOs) targeting a protected volume of a protected site;
copying the incoming write IOs to a protected mini journal of the protected site for replication to a vault volume of a vault site, wherein communication to the vault site is disabled during periodic intervals of predefined length and enabled between the periodic intervals;
determining a limit on a synchronization rate for movement of synchronization data from the protected volume to the protected mini journal during a current periodic interval, based on an estimate of remaining capacity of the protected mini journal that will be used by incoming write input/outputs (IOs) during the respective periodic interval;
writing the synchronization data from the protected volume to the protected mini journal at a rate no greater than the determined limit; and
at the end of the current periodic interval, replicate the protected mini journal to a vault mini journal of the vault site.

9. The processor-implemented method of claim 8, wherein the estimate of remaining capacity of the protected mini journal that will be used by the incoming write IOs during the respective periodic interval is determined based upon:
a rate of incoming write IOs in at least one of: the current periodic interval or one or more prior periodic intervals;
an amount of available capacity remaining in the protected mini journal; and
a time left before an end of the current periodic interval.

10. The processor-implemented method of claim 9, wherein the limit on the synchronization rate is calculated by:
predicting the estimate of remaining capacity of the protected mini journal that will be used by incoming write IOs by multiplying the rate of write IOs by an amount of time left before the end of the current periodic interval;
predicting a synchronization data capacity of the protected mini journal by subtracting the estimate of capacity of the protected mini journal that will be used by the incoming write IOs from the amount of available capacity remaining in the protected mini journal; and
dividing the synchronization data capacity by the amount of time left before the end of the current periodic interval to obtain the limit on the synchronization rate.

11. The processor-implemented method of claim 9, wherein the rate of write IOs comprises a maximal rate of: a maximal rate of write IOs in the current periodic interval and a maximal rate of write IOs in the one or more prior periodic intervals.

12. The processor-implemented method of claim 8, comprising:
identifying data written to the protected volume that is out of synchronization at the vault volume and is not in-flight to the vault volume via the mini journal or the vault mini journal as the synchronization data.

13. The processor-implemented method of claim 12, comprising:
identifying one or more write IOs not copied to the protected mini journal due to lack of capacity of the protected mini journal as the synchronization data.

14. The processor-implemented method of claim 8, wherein the limit on the synchronization rate comprises at least one of: a rate limit on reading the synchronization data from the protected volume or a rate limit on writing the synchronization data to the protected mini journal.

15. A non-transitory computer-readable medium comprising computer-readable instructions that are executable by one or more processors to:
receive incoming write input/outputs (IOs) targeting a protected volume;
copy the incoming write IOs to a mini journal for replication to a vault volume of a vault storage device, wherein communication to the vault storage device is disabled during periodic intervals of predefined length and enabled between the periodic intervals;
determine a limit on a synchronization rate for movement of synchronization data from the protected volume to a mini journal during a current periodic interval, based on:
a rate of write input/outputs (IOs) in at least one of: the current periodic interval or one or more prior periodic intervals;
an amount of available capacity remaining in the mini journal; and
a time left before an end of the current periodic interval;
writing at least some of the synchronization data from the protected volume to the mini journal at a rate no greater than the determined limit; and
at the end of the current periodic interval, replicate the mini journal to a vault mini journal of the vault storage device.

16. The non-transitory computer-readable medium of claim 15, comprising computer-readable instructions that are executable by the one or more processors to:
during at least one of the periodic intervals:
identify that all of the synchronization data has been written to the mini journal; and
in response to identifying that all of the synchronization data has been written to the mini journal, copy the incoming write IOs to the mini journal without further synchronization data from the protected volume.

17. The computer-readable medium of claim 15, comprising computer-readable instructions that are executable by the one or more processors to:
identify at least one of: one or more write IOs not copied to the mini journal due to lack of capacity of the mini journal or data stored in the protected volume prior to initializing copying the incoming write IOs to the mini journal as the synchronization data.

18. The computer-readable medium of claim 15, comprising computer-readable instructions that are executable by the one or more processors to:
calculate the limit on the synchronization rate by:
predicting an expected capacity of the mini journal that will be used by incoming write IOs by multiplying the rate of write IOs by an amount of time left before the end of the current periodic interval;
predicting a synchronization data capacity of the mini journal by subtracting the expected capacity of the mini journal that will be used by the incoming write IOs from the amount of available capacity remaining in the mini journal; and
dividing the synchronization data capacity by the amount of time left before the end of the current periodic interval to obtain the limit on the synchronization rate.

19. The computer-readable medium of claim 15, comprising computer-readable instructions that are executable by the one or more processors to:
calculate the rate of write IOs as a maximal rate of: a maximal rate of write IOs in the current periodic interval and a maximal rate of write IOs in the one or more prior periodic intervals.

20. The computer-readable medium of claim 15, wherein the limit on the synchronization rate comprises at least one of: a rate limit on reading the synchronization data from the protected volume or a rate limit on writing the synchronization data to the mini journal.
